(19) United States
(12) Patent Application Publication
(10) Pub. No.: US 2020/0378696 A1
(43) Pub. Date: Dec. 3, 2020

(54) HEAT EXCHANGER COMPRISING CONNECTORS WITH SUPPORTS

(71) Applicant: L'Air Liquide, Société Anonyme pour I'Etude et I'Exploitation des Procédés Georges Claude, Paris (FR)

(72) Inventors: Matthieu FLIN, Vanves (FR); Olivier DUBET, Buc (FR); Raphael FAURE, Saint Rémy les Chevreuse (FR); Pascal DEL-GALLO, Dourdan (FR)

(21) Appl. No.: 16/497,248

(22) PCT Filed: Mar. 16, 2018
(86) PCT No.: PCT/FR2018/050639

§ 371 Date: Sep. 24, 2019

(30) Foreign Application Priority Data
Mar. 24, 2017 (FR) 1752488

(51) Int. Cl. F28F 9/02; B33Y 80/00; B22F 3/105

(52) U.S. Cl. CPC F28F 9/0278; F28F 2255/18; B22F 3/1055; B33Y 80/00

(57) ABSTRACT

A single-component exchanger permitting a transfer of heat between a first fluid and a second fluid is provided. The heat exchanger includes, from bottom to top in the direction of manufacture; at least two distribution regions, at least two collection regions, at least two inlet connectors adjoining the at least two distribution regions and at least two outlet connectors adjoining the at least two collection regions. The heat exchanger also includes at least one inlet located on each inlet connector, at least one outlet located on each outlet connector, and an exchange region permitting a transfer of heat between the channels of the first fluid and the channels of the second fluid. Each connector includes supports in the inner upper part thereof.

### CROSS REFERENCE TO RELATED APPLICATIONS

This application is a 371 of International PCT Application No. PCT/FR2018/050639, filed Mar. 16, 2018, which claims priority to French Patent Application No. FR 1752488, filed Mar. 24, 2017, the entire contents of which are incorporated herein by reference.

### BACKGROUND

The present invention relates to single-component millistructured exchangers, that is to say those having no assembly interface.

### SUMMARY

More precisely, it relates to millistructured exchangers used in industrial processes which require that these devices operate at a (i) high temperature/pressure pair, (ii) with minimal pressure drops and (iii) permitting intensification of the process such as the use of a compact plate-type exchanger for preheating oxygen used in the context of an oxycombustion process.

A millistructured exchanger is an exchanger which includes elements such as the “stages”, the “walls”, the “distribution regions” and the “collection regions”. The channels of millistructured exchangers may also be filled with solid shapes such as foams with the aim of improving exchanges of heat. The thermal integration of these devices may be the subject of far-ranging optimizations serving to optimize the exchanges of heat between the fluids flowing in the device at different temperatures by virtue of a spatial distribution of the fluids over multiple stages and the use of multiple distributors and collectors. For example, the millistructured exchangers proposed for preheating the oxygen in a glass furnace consist of a multitude of millimeter-scale passages arranged on various stages and which are formed by interlinked channels. The channels can be supplied with hot fluids (that is to say at a temperature of between 500 and 950° C.) by one or more distributors. The cooled and heated fluids are conveyed out of the device by one or more collectors.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic representation illustrating connectors at various locations on the exchanger, in accordance with one embodiment of the present invention;

FIG. 2 is a schematic representation illustrating an exchanger constructed vertically by an additive method, in accordance with one embodiment of the present invention;

FIG. 3 is a schematic representation illustrating the supports positioned between the inlets and outlets, in accordance with one embodiment of the present invention;

FIG. 4 is a schematic representation illustrating another embodiment with the supports positioned between the inlets and outlets, in accordance with one embodiment of the present invention; and

FIG. 5 is a schematic representation illustrating another embodiment with the supports positioned between the inlets and outlets, in accordance with one embodiment of the present invention.

### DETAILED DESCRIPTION OF PREFERRED EMBODIMENTS

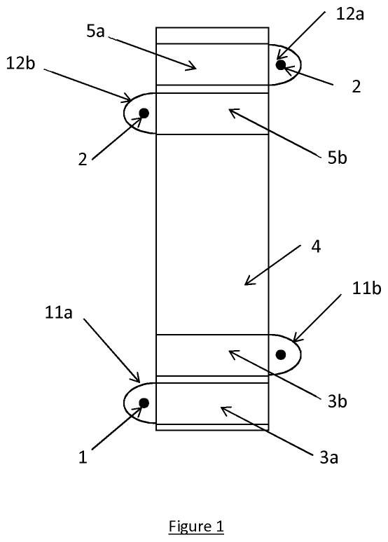

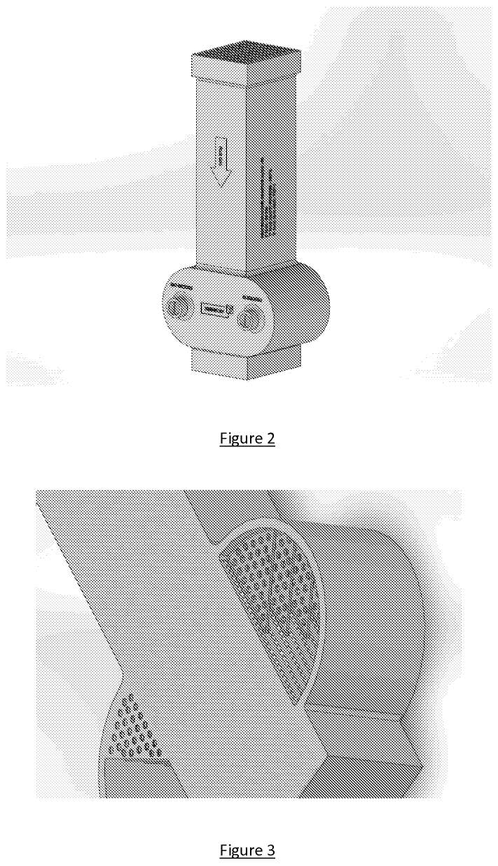

The exchanger to which this invention relates is a single-component unit consisting of various parts, which are shown in FIG. 1 or FIG. 2. A “single-component exchanger” is to be understood as an exchanger having no assembly interface. The inlet 1 and the outlet 2 of the exchanger are respectively connected to inlet connectors 11 and to outlet connectors 12, which are themselves directly connected respectively to a distribution region 3 and a collection region 5 which supplies the exchange region 4. The exchange region 4 consists of channels, a distinction being made between the hot fluid channels and the cold fluid channels.

The inlet connector 11 and outlet connector 12 may be defined as a volume that is at least 50% empty, preferably at least 70% empty, and that respectively connects the inlet and the distribution region, and the collection region and the outlet.

The “distribution region” is to be understood as a volume that is arranged so as to best distribute the flows entering or leaving the channels of the exchange region.

In order to allow the single-stage manufacture of an exchanger as described above, it is necessary for the inlet connector and outlet connector to be manufactured by an additive method at the same time as the distribution region and the exchange region.

However, without limiting the positioning or size possibilities of the connectors, there is currently no solution which permits the manufacture of the connectors at the same time as the exchange region and the distribution region.

Hence, there is a need to provide an improved exchanger and/or an improved process with which it is possible to manufacture the connectors at the same time as the exchange region and the distribution region.

This point is especially important since this equipment can be multi-fluidic (more than 2 fluids exchanging heat) and therefore requires the same number of inlet/outlet connectors to be arranged on the various faces of the exchanger.

One solution of the present invention is a single-component exchanger permitting a transfer of heat between a first fluid and a second fluid and comprising, from bottom to top in the direction of manufacture:
at least two distribution regions 3a and 3b;
at least two collection regions 5a and 5b;
at least two inlet connectors 11a and 11b adjoining the distribution regions and at least two outlet connectors 12 adjoining the collection regions;
at least one inlet 1 located on each inlet connector;
at least one outlet 2 located on each outlet connector;
an exchange region 4 permitting a transfer of heat between the channels of the first fluid and the channels of the second fluid;
   with each connector comprising supports in the inner upper part thereof.
   The first fluid is generally referred to as the “hot” fluid and the second fluid is generally referred to as the “cold” fluid.

It is to be noted that the channels in question are millimeter-scale channels.

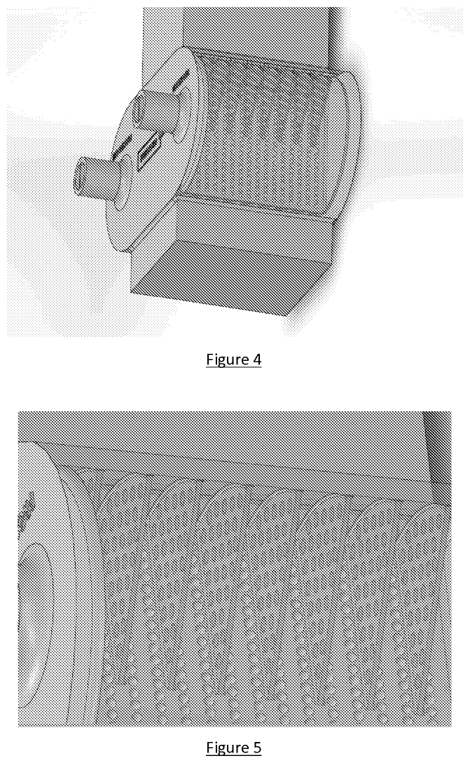

Depending on the case, the exchanger according to the invention may have one or more of the following features:
said exchanger is a multi-fluid exchanger and the exchange region permits a transfer of heat between the channels of at least a first fluid, a second fluid and a third fluid.
said exchanger comprises at least three inlet connectors and/or at least three outlet connectors.
each distribution region 3 comprises, on its face adjoining the inlet connector 11, flow inlets arranged on several vertical axes; the supports included in the inner upper part of the inlet connector 11 have one face adjoining the distribution region 3 and one face adjoining the inner upper face of the inlet connector 11; and the supports are interposed between said various vertical axes.
each collection region 5 comprises, on its face adjoining the outlet connector 12, flow outlets arranged on several vertical axes; the supports included in the inner upper part of the outlet connector 12 have one face adjoining the collection region 5 and one face adjoining the inner upper face of the outlet connector 12; and the supports are interposed between said various vertical axes.
the supports are in the shape of a sector of a disk having an angle of between 30 and 60°, preferably between 40 and 50°.
the connectors have an internal diameter “D” and the supports in the shape of a sector of a disk have a radius “d” such that ¼D≤d≤⅓D.
the supports have a porosity of between 25 and 45%, preferably a porosity of between 35% and 45%.
the supports have a thickness of less than 2 mm, preferably less than 1 mm, more preferably less than 0.8 mm.
the flow inlets of the distribution regions and/or the flow outlets of the collection regions have a hydraulic diameter of between 0.3 and 4 mm, preferably 0.5 and 2 mm.
said exchanger is manufactured in one piece by additive manufacturing.
   The channels of the exchange region are spread over several stages. “Stage” is to be understood as a set of channels located at the same level. The channels are separated by walls. “Wall” is to be understood as a separating partition between two consecutive channels. The number of channels, their dimensions and their arrangements are determined so as to be able to achieve the expected performance in terms of heat transfer, while abiding by the imposed pressure drop. The flows are conveyed in the channels via a region termed the distribution region. The distribution region permits even distribution of the flows between the channels that are open thereto.
   The additive manufacturing process can use micrometer-scale metal powders which are melted by one or more lasers so as to manufacture finished parts having complex three-dimensional shapes. The part is built up layer by layer, the layers are of the order of 50 μm, depending on the precision of the desired shapes and the desired deposition rate. The metal that is to be melted can be supplied either by a powder bed or by a spray nozzle. The lasers used to locally melt the powder are YAG, fiber or CO2 lasers, and the powder is melted under an inert gas (argon, helium, etc.). The present invention is not restricted to a single additive manufacturing technique, but applies to all known techniques.
   Additive manufacturing techniques make it possible ultimately to produce parts that are said to be “solid” and which, in contrast to construction techniques such as diffusion brazing or diffusion welding, have no assembly interfaces between each engraved plate. This property increases the mechanical strength of the device, since the way in which the device is built eliminates weakening lines and thus eliminates a source of potential defects.
   The production of solid parts by additive manufacturing, and the elimination of diffusion brazing or welding interfaces, makes it possible to conceive of numerous design possibilities without being limited to wall geometries that have been studied in order to limit the impact of possible construction defects such as discontinuities in the brazed joins or in the diffusion welded interfaces.
   Additive manufacturing makes it possible to produce shapes that would be inconceivable with traditional manufacturing methods, and thus the manufacture of the connectors of the millistructured exchangers can be performed in continuation of the manufacture of the body of the devices. This then makes it possible to not carry out an operation of welding the connectors to the body, and hence makes it possible to eliminate a source of weakening of the structural integrity of the equipment.
   The supports in the inner upper part of the connectors make it possible to manufacture the connectors of the exchanger by means of an additive method, without this being limited in terms of the position of the connectors at the level of the exchanger. Indeed, FIG. 1 shows the possibility of having connectors at various locations on the exchanger.
   The supports must be positioned in the connectors at those points where the manufacture by an additive method will require support. For example in the case of an exchanger constructed vertically by an additive method, as shown in FIG. 2. For the sake of simplicity, FIG. 2 shows only two connectors.
   The supports of the connectors are located in the inner upper part of the connectors.
   In order to minimize the impact on the manufacturing method, and to not disturb the circulation of the flows, the distribution and collection thereof at the flow inlets and outlets of the distribution region and of the collection region, the supports are positioned between the inlets and outlets, which dictates their thickness (see FIGS. 3, 4 and 5).
   Moreover, so as to not disturb the circulation of the flows, the supports are preferably perforated and have a high porosity of between 25 and 45%, with an ideal value of 40% (calculated as the ratio of the combined volume of the holes of the supports to the total volume occupied by a support).
   The present invention also relates to an oxycombustion process using an exchanger as claimed in one of the claims for preheating oxygen.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-12. (canceled)

13. A single-component exchanger permitting a transfer of heat between a first fluid and a second fluid and comprising, from bottom to top in the direction of manufacture:
at least two distribution regions,
at least two collection regions,
at least two inlet connectors adjoining the at least two distribution regions and at least two outlet connectors adjoining the at least two collection regions,
at least one inlet located on each inlet connector,
at least one outlet located on each outlet connector, and
an exchange region permitting a transfer of heat between the channels of the first fluid and the channels of the second fluid,
with each connector comprising supports in the inner upper part thereof.

14. The exchanger as claimed in claim 13, wherein the exchanger is a multi-fluid exchanger and the exchange region permits a transfer of heat between the channels of at least a first fluid, a second fluid and a third fluid.

15. The exchanger as claimed in claim 14, wherein the exchanger comprises at least three inlet connectors and/or at least three outlet connectors.

16. The exchanger as claimed claim 13, wherein:
each of the at least two distribution region comprises, on a face adjoining the inlet connector, flow inlets arranged on several vertical axes,
the supports included in an inner upper part of the inlet connector have one face adjoining the at least two distribution region and one face adjoining an inner upper face of the inlet connector, and
the supports are interposed between the various vertical axes.

17. The exchanger as claimed in claim 13, wherein:
each of the at least two collection region comprises, on a face adjoining the outlet connector, flow outlets arranged on several vertical axes,
the supports included in the inner upper part of the outlet connector have one face adjoining the collection region and one face adjoining an inner upper face of the outlet connector; and
the supports are interposed between the various vertical axes.

18. The exchanger as claimed in claim 13, wherein the supports are in the shape of a sector of a disk having an angle of between 30 and 60°.

19. The exchanger as claimed in claim 18, wherein the at least two inlet connectors and/or the at least two outlet connectors have an internal diameter “D” and the supports in the shape of a sector of a disk have a radius “d” such that ¼D≤d≤⅓D.

20. The exchanger as claimed in claim 12, wherein the supports have a porosity of between 25 and 45%.

21. The exchanger as claimed in claim 12, wherein the supports have a thickness of less than 2 mm.

22. The exchanger as claimed in claim 12, wherein the flow inlets of the distribution regions and/or the flow outlets of the collection regions have a hydraulic diameter of between 0.3 and 4 mm.

23. The exchanger as claimed in claim 12, wherein the exchanger is manufactured in one piece by additive manufacturing.

24. An oxycombustion process using an exchanger as claimed in claim 12 for preheating oxygen.
